(19) United States
(12) Patent Application Publication
(10) Pub. No.: US 2016/0047356 A1
(43) Pub. Date: Feb. 18, 2016

(54) ROTOR BLADE OF A WIND TURBINE

(71) Applicant: Wobben Properties GmbH, Aurich (DE)

(72) Inventors: Torsten PAWlS, Südbrookmerland (DE); Falk MIDDELSTÄDT, Westerstede (DE); Thomas SCHULZE, Jöhstadt (DE); Florian RUBNER, Aurich (DE)

(21) Appl. No.: 14/783,039

(22) PCT Filed: Apr. 9, 2014
(86) PCT No.: PCT/EP2014/057120

§ 371 Date: Oct. 7, 2015

(30) Foreign Application Priority Data
Apr. 11, 2013 (DE) 102013206493.4

(51) Int. Cl. F03D 1/06; F03D 11/00; F03D 1/00

(52) U.S. Cl. CPC F03D 1/0675; F03D 1/0658; F03D 1/001; F03D 11/0025

(57) ABSTRACT

The invention relates to a rotor blade of a wind turbine, having a rotor blade nose, a rotor blade rear edge, a rotor blade root region for the attachment of the rotor blade to a hub of the wind turbine, a rotor blade tip, wherein the rotor blade extends from the rotor blade root region along a longitudinal direction to the rotor blade tip and the rotor blade internally comprises at least a first cavity facing the rotor blade nose and a second cavity facing the rotor blade rear edge, and the first cavity is heated by a first, and the second cavity is heated by a second heating means, in order to heat the rotor blade nose or the rotor blade rear edge respectively. In addition, it is suggested that the rotor blade have a rear edge segment disposed in the region of the rotor blade rear edge up to the root region, wherein the rear edge segment is designed having several parts having at least two segment sections.

### BACKGROUND

1. Technical Field

The present invention relates to a rotor blade of a wind turbine as well as to a wind turbine. Moreover, the present invention relates to a method of manufacturing a rotor blade and the present invention relates to a method of installing a wind turbine. Moreover, the present invention relates to a rear edge segment of a rotor blade of a wind turbine.

2. Description of the Related Art

Wind turbines are generally known and FIG. 1 schematically shows a wind turbine. The rotor blades are an important component of a wind turbine. These blades transform kinetic energy from the wind into kinetic energy for driving a generator.

In order to increase the efficiency of wind turbines, these wind turbines or wind power installations are increasingly being built larger. This has also led to the development and the design of larger rotor blades. Larger rotor blades are thereby often difficult to transport on the road. On the one hand, the length of the rotor blades is at issue, but on the other hand, the width of the rotor blades in the root region thereof may also be at issue, at least in the case of modern rotor blades, the greatest width of which is in the region of the root of the rotor blade. Here, modern rotor blades may have a width of 5 or more meters.

During operation, the rotor blades are exposed to the wind accordingly and depending on the temperature and humidity of the wind, this may result in the formation of ice deposits on the respective rotor blade. Here, an ice layer forms on the rotor blade or partially forms on only some regions of the rotor blade. This formation of ice deposits affects the optimum operation of the wind turbine. In particular, the formation of ice deposits poses a danger of ice shedding.

In the case of an accretion of ice, the wind turbine must consequently frequently be stopped for safety reasons. There are already known suggestions for preventing an accretion of ice or thawing the ice that has already accumulated on the rotor blade by means of heating the rotor blades.

Such heating of a rotor blade can be costly, however, and the outcome may be uncertain. The problem may arise that it is not precisely known in which regions of the rotor blade an accretion of ice has occurred, or whether an accretion of ice has occurred at all.

The German Patent and Trademark Office has researched the following prior art in the priority application: DE 195 28 862 A1, DE 10 2008 045 578 A1, DE 200 14 238U1, U.S. Pat. No. 4,295,790 A, EP 1 965 074 A2, EP 2 602 455 A1.

### BRIEF SUMMARY

One or more embodiments of the present invention may address at least one of the problems mentioned above. In particular, a solution is proposed that improves the manufacture and transportation of rotor blades. In addition or alternatively, a solution for the problem of an accretion of ice on a rotor blade is proposed. At least one alternative solution is proposed.

In one embodiment a rotor blade of a wind turbine comprises a rotor blade nose and a rotor blade rear edge. In the case of the intended movement of the rotor blade, the rotor blade nose is essentially directed in the direction of movement, thus the rotational direction, of the rotor blade and therefore of the aerodynamic rotor of the wind turbine. The rotor blade rear edge is directed in the opposite direction.

Moreover, the rotor blade has a rotor blade root region, at which the rotor blade is connected to a hub of the wind turbine. In addition, a rotor blade tip is provided, which essentially faces away from the root region. The rotor blade root region is directed inward towards the hub and the rotor blade tip is directed outward towards the side facing away from the hub relative to the rotor of the wind turbine in which the rotor blade carries out its duties. The rotor blade thus extends in a longitudinal direction from the rotor blade root region along a longitudinal direction to the rotor blade tip.

Internally, the rotor blade has at least a first cavity, which is directed towards the rotor blade nose, thus disposed in the interior of the rotor blade in the region of the rotor blade nose, and has a second cavity, which is directed towards the rotor blade rear edge, thus disposed in the interior of the rotor blade in the region of the rotor blade rear edge.

The first cavity and the second cavity are heated by a first or a second heating means respectively, in order to heat the rotor blade nose or the rotor blade rear edge respectively. Thus the rotor blade nose is heated by the first cavity, and the rotor blade rear edge is heated by the second cavity.

Thus separate heating means are provided, which on the one hand are able to heat both the rotor blade nose and the rotor blade rear edge, however on the other hand are able to heat the rotor blade in a targeted and differentiated manner depending on the provided control. Thus it is optionally possible to heat only the rotor blade nose or only the rotor blade rear edge. Different heating strengths or different durations of heating may also be provided. In contrast to the use of only one heating means, not only can said heating be done in a differentiated manner, but also a higher overall heating power can be achieved even if this is not always demanded.

If only a single heating means is used, frequently only a single region can be heated. If a heater current is diverted to a plurality of regions, said current may indeed reach a plurality of regions, however it will cool down such that the regions that can only be reached late as a result of this diversion can scarcely be heated with the thus cooled air current. Such problems are avoided through the use of two heating means.

Both heating means are preferably disposed in the region of the rotor blade root and they heat air and blow this air into the respective cavity. Such heating means may in particular be formed as heater blowers or the like, and may blow the heated air into the first cavity in order to heat the rotor blade nose and into the second cavity in order to heat the rotor blade rear edge, wherein in so doing, at least one heating means, thus in each case, one heater blower specified in the example, may be used in each above mentioned cavity.

A middle cavity is preferably disposed between the first and the second cavity. From the rear edge outward when viewed in the direction of movement of the rotor blade, the rotor blade thus first has the second cavity for heating the rotor blade rear edge, then the middle cavity, and subsequently the first cavity, which is located essentially behind the rotor blade nose.

It is now proposed that air for heating be conducted both through the first and also through the second cavity of the rotor blade root in the direction of the rotor blade tip. This does not necessarily mean that the air for heating reaches the rotor blade tip, but rather that the air is initially conducted in this direction. However, the rotor blade may be designed such that at least one of the heated air currents reaches the rotor blade tip. To this end, it is now suggested that the air, thus the at least two air currents, be returned together to the root region by means of the middle cavity. Accordingly, cool or at least cooled air flows through this middle cavity back to the root region.

The air thus returned is preferably reheated by the at least two heating means and blown into the first or second cavity respectively for heating. A desired circulation for heating the rotor blade is hereby created. Purely as a precaution, it is explained here that naturally the returned air is only heated in part by the one heating means, and in part by the other heating means, and is further used for heating.

These heating means are preferably operated separately from one another. To this end it is suggested in particular that these heating means may be separately controlled. Such a control may be achieved by means of a central control unit of the wind turbine. To this end, the wind turbine may evaluate, for example, in which region of the rotor blade a formation of ice deposits exists, or at least where it may be assumed to exist. For example, if a formation of ice deposits is only detected in one region of the rotor blade nose, heating may be limited to this region in a targeted manner.

According to one embodiment, the rotor blade is divided internally into at least two or three cavities in at least one section by stiffening partitions. In particular, at least two stiffening partitions are provided, which specifically extend essentially parallel to one another from the rotor blade root region in the direction of the rotor blade tip, between which stiffening partitions the middle cavity is formed. These stiffening partitions need not extend directly to the rotor blade root, and they also need not extend all the way to the rotor blade tip, but they could extend that far. By means of this suggested embodiment, stiffening struts of the rotor blade may be skillfully used to guide air currents for heating the rotor blade. The specified differentiated heating of the rotor blade can therefore be implemented in a comparatively simple manner.

In another embodiment, a rotor blade has a rear edge segment in the region of the rotor blade rear edge that extends to the root region of the rotor blade. Such a rear edge segment is thus disposed in the region of the rotor blade rear edge, or forms it respectively in a section of the rotor blade. In addition, this rear edge segment is disposed extending to the rotor blade hub, thus it is disposed internally relative to the aerodynamic rotor of the wind turbine. It is now suggested that this rear edge segment be designed having several parts. This division into multiple parts refers to the fact that a plurality, specifically at least two segment sections be provided. The division into multiple parts thus does not relate to the provision of various fastenings such as screws, but rather refers to the rear edge segment as such.

It is hereby in particular possible to provide these segments for different manufacturing and installation steps or situations respectively. The rotor blade can be initially manufactured without this rear edge segment. For example, a first essential manufacturing process of the rotor blade, which is mentioned here merely as an example, may be the manufacture of a winding form, in particular a winding form made of glass-fiber reinforced plastic (GRP). A first part or a first section respectively, thus a first segment section, of the rear edge segment may be attached. A first further shaping may hereby occur. A further section of the rear edge segment may be completed later, in particular after transport of the rotor blade to an installation site. The second or additional segment section or segment sections respectively may then be attached to the rotor blade at the installation site, in order to finally produce the final form of the rotor blade.

In the case of the rear edge segment, it is preferably suggested that this segment extend out from the rotor blade root region for at least 40 percent of the length of the rotor blade to the rotor blade tip, preferably even more than 45 percent, in particular approximately 50%. It may hereby be achieved that the rotor blade can be formed in the rear edge region at this length. The remaining part of the rotor blade may thereby be manufactured separately. A high width of the rotor blade may be provided, which thus may be realized by the rear edge segment, in particular in the region of the rotor blade which is facing the hub, thus which is facing the root region of the rotor blade.

The rotor blade preferably has a rotor blade body and the rear edge segment, wherein the rear edge segment is provided as a separate component and, as such, is attached to the main body or to the rotor blade body respectively. In so doing, the rotor blade body, which may simply be referred to as the main body, ensures the stability of the rotor blade along its entire length. The rotor blade body thus also forms the support structure of the rotor blade. In so doing, it was recognized that it may be sufficient to use such a rotor blade body as a central stable element, such that even in the region near the hub, the full width is not needed in order to achieve the stability of the rotor blade. It is thereby suggested that the rear edge segment be provided for a very large length, specifically more than 40 percent or more than 45 percent of the length of the blade, in particular approximately half of the length, in order to also dispense with a corresponding width of the rotor blade main body in this region.

The rear edge segment is preferably allocated in a base section for attachment to the main body, and an edge section is preferably allocated for attachment to the base section. These sections may be attached to the blade at different points in time during manufacturing, and also at different manufacturing or installation sites respectively. The attachment of the base section preferably occurs before transport of the rotor blade and the attachment of the edge section preferably occurs after transport to the installation site.

It is suggested that the base section and in addition or alternatively the edge section themselves again preferably be divided into at least two or more parts. The installation, specifically attachment to the main body or base section respectively can hereby be simplified.

In particular a subdivision of the edge section simplifies the attachment thereof to the base section at the installation site. That is, other tools are regularly available at the installation site than is the case in the manufacturing hall. Such a rear edge segment may thereby be adapted by means of the suggested subdivision and sub-subdivision.

The rotor blade is preferably structured in such a way that the rear edge segment is attached to the rotor blade body merely as a casing, which rotor blade body forms the support structure of the rotor blade. The rear edge segment thus does not contribute to the supporting structure. The rear edge segment, or parts thereof, may be adhered to the rotor blade body for example. The multi-part configuration of the rotor blade makes it possible to achieve a reduction in the load so that the formation of cracks may be reduced. The assembly may also be optimized.

The rotor blade body preferably extends out from the root region, in particular from a rotor blade flange, in a straight line in a longitudinal direction, in particular in a straight line to a middle region of the rotor blade, thus without tapering in this direction. This straight gradient may be provided for up to more than 40%, in particular more than 45%, preferably up to approximately half of the rotor blade.

The provision of such a rotor blade body, which is essentially straight in one section, may also achieve geometric discontinuities and/or curves in the region of the rotor blade, thus in the inner region of the rotor blade facing the hub relative to the rotor of the wind turbine.

Considerable savings in weight can be achieved by means of this design.

Thus, a rear edge segment of a rotor blade is also suggested, which rear edge segment is designed having several parts, as was explained above within the context of some embodiments of a rotor blade.

Such a rear edge segment is preferably prepared for use on a rotor blade pursuant to at least one of the above described embodiments. In particular the rear edge segment has the respective features that were described for a rear edge segment in conjunction with an embodiment of a rotor blade.

In addition, a wind turbine having a rotor blade pursuant to one of the above described embodiments is also suggested.

In addition, a method of manufacturing a rotor blade is suggested. It is hereby suggested that a rotor blade body first be manufactured. A base section of a rear edge segment is subsequently manufactured. In addition, an edge section of the rear edge segment is manufactured. As a further step, the base section is attached to the rotor blade body and finally the edge section is attached to the base section, which is already attached to the rotor blade body.

In addition, a method of installing a wind turbine is suggested, wherein this wind turbine has at least one rotor blade. This method of installation suggests that the rotor blade or each of the rotor blades of the wind turbine, respectively, be manufactured as described above. For this installation method it is thereby suggested, however, that the rotor blade body be transported to the installation site of the wind turbine having an attached base section. The edge section is transported separately to the installation site, or at least said edge section is transported to the installation site of the wind turbine in a state of not being attached to the base section. The edge section is then only attached to the base section at the installation site. Additional steps for installing the wind turbine are then performed in a conventional manner by the person skilled in the art.

With respect to the rotor blade, an advantage of a long rear edge segment is that a stable attachment to the rotor blade body can thereby be achieved, or the attachment can be improved respectively, in particular in terms of the stability and durability as compared to shorter rear edge boxes or rear edge segments respectively.

It is preferably proposed that a rotor blade have an erosion protection cover in the rotor blade nose thereof. The rotor blade nose may hereby be protected against erosion, which may occur during the operation of the wind turbine, in particular as a result of the rotating movement of the rotors with the rotor blades. Such an erosion protection cover is provided as a separate component, which is attached to the rotor blade, in particular to the rotor blade body. Thus an essential component of the rotor blade, specifically the rotor blade body, may be manufactured separately and in particular having a higher stability of the rotor blade in terms of a lower weight. A protected rotor blade nose and a special rotor blade rear edge may each be added by means of a separate part or by means of a plurality of separate parts. A flexibility in the manufacture and in the configuration of the rotor blade can thereby be achieved.

### BRIEF DESCRIPTION OF THE SEVERAL VIEWS OF THE DRAWINGS

The invention is now described in more detail below using embodiments as examples with reference to the accompanying figures.

FIG. 1 shows a perspective view of a wind turbine.

FIG. 2 shows a sectional view of a rotor blade having a section perpendicular to the rotor blade axis, in a schematic illustration.

FIG. 3 shows a section of a rotor blade root in a perspective, semi-transparent view to illustrate possible air flows in the rotor blade.

FIG. 4 shows a rotor blade root in a perspective, semi-transparent view having two heating means.

FIG. 5 schematically shows an axial view of a rotor blade at the rotor blade root region in order to illustrate a plurality of cavities that conduct air currents.

FIG. 6 shows a heating means in a perspective illustration.

FIGS. 7 to 9 show a top view of a rotor blade in various manufacturing states.

### DETAILED DESCRIPTION

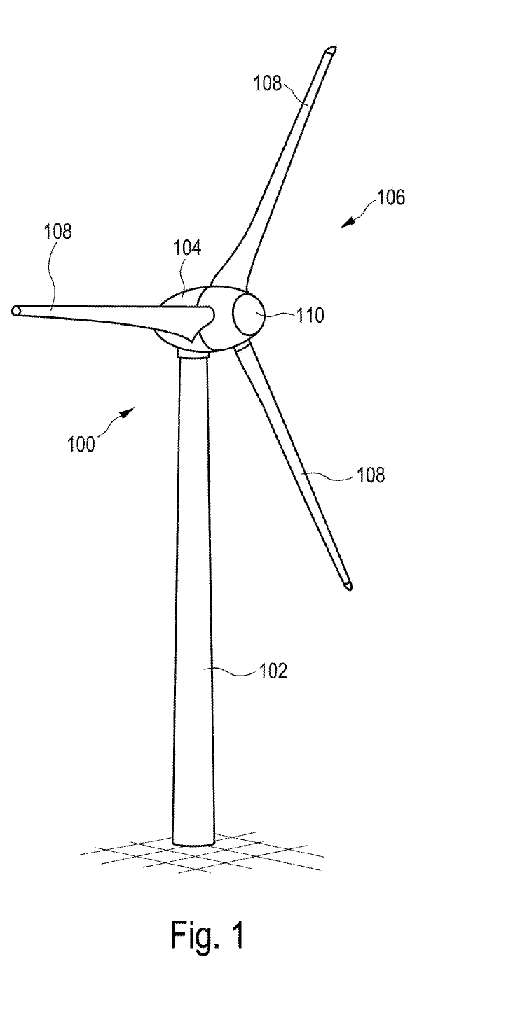

FIG. 1 shows a wind turbine 100 with a tower 102 and nacelle 104. A rotor 106 with three rotor blades 108 and a spinner 110 is located on the nacelle 104. When in operation, the rotor 106 is brought to a rotating movement by the wind and thereby drives a generator in the nacelle 104.

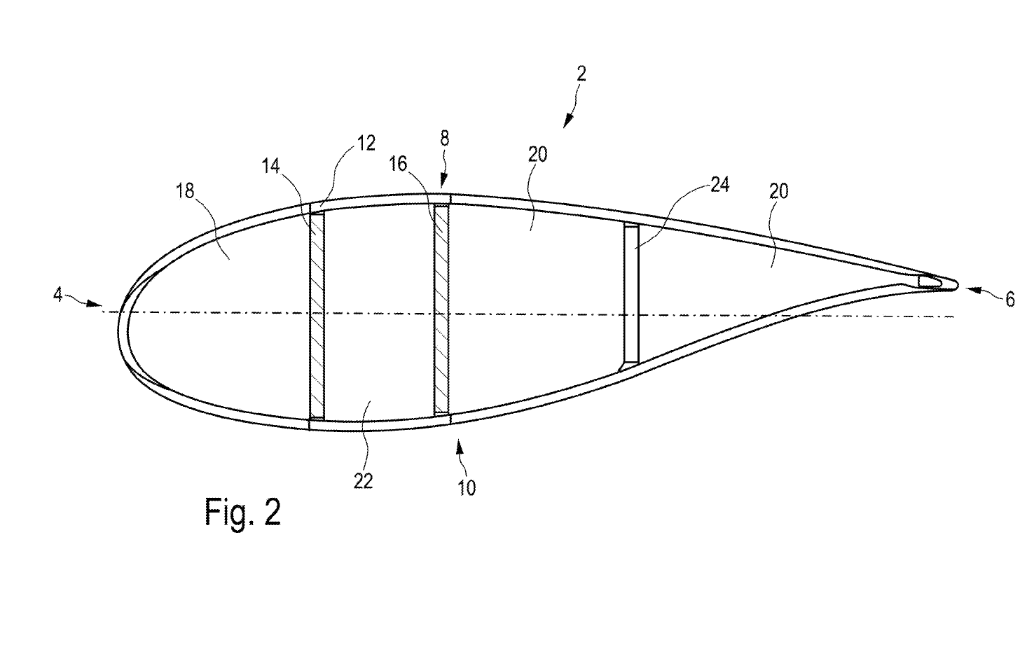

FIG. 2 shows a cross-section of a rotor blade 2 having a rotor blade nose 4 and a rotor blade rear edge 6. The illustrated cross-section shows a profile of the rotor blade 2 approximately in the middle region thereof with respect to the longitudinal direction of the rotor blade. Moreover, the profile has a suction side 8 and a pressure side 10. A first and a second stiffening partition 14 or 16 respectively inter alia are provided in order to stiffen the outer shell 12. Both stiffening partitions 14 and 16 are hatched and thereby represented as cut elements, and they form continuous walls and divide the rotor blade 2, at least in the region shown, into a first cavity 18, which faces the rotor blade nose 4, into a second cavity 20, which faces the rotor blade rear edge 6, and into a middle cavity 22, which is disposed between the two stiffening partitions 14 and 16.

A stiffening brace 24 is illustrated in the region of the second cavity 20, which stiffening brace is not continuous in the longitudinal direction however and, in this respect, does not divide the second cavity 20 into two cavities. The outer shell 12 is also not hatched in the illustration, in order to increase the clarity of FIG. 2. In fact, the outer shell 12 pursuant to the illustration in FIG. 2 is also cut, and thus extends as a continuous outer shell in the longitudinal direction of the rotor blade.

It is suggested for the rotor blade shown in FIG. 2 that hot air current be introduced separately for the first and second cavity 18 and 20 respectively. These two hot air currents or warm air currents may then together be recycled back through the middle cavity 22 when they have been cooled by heating the respective section of the rotor blade.

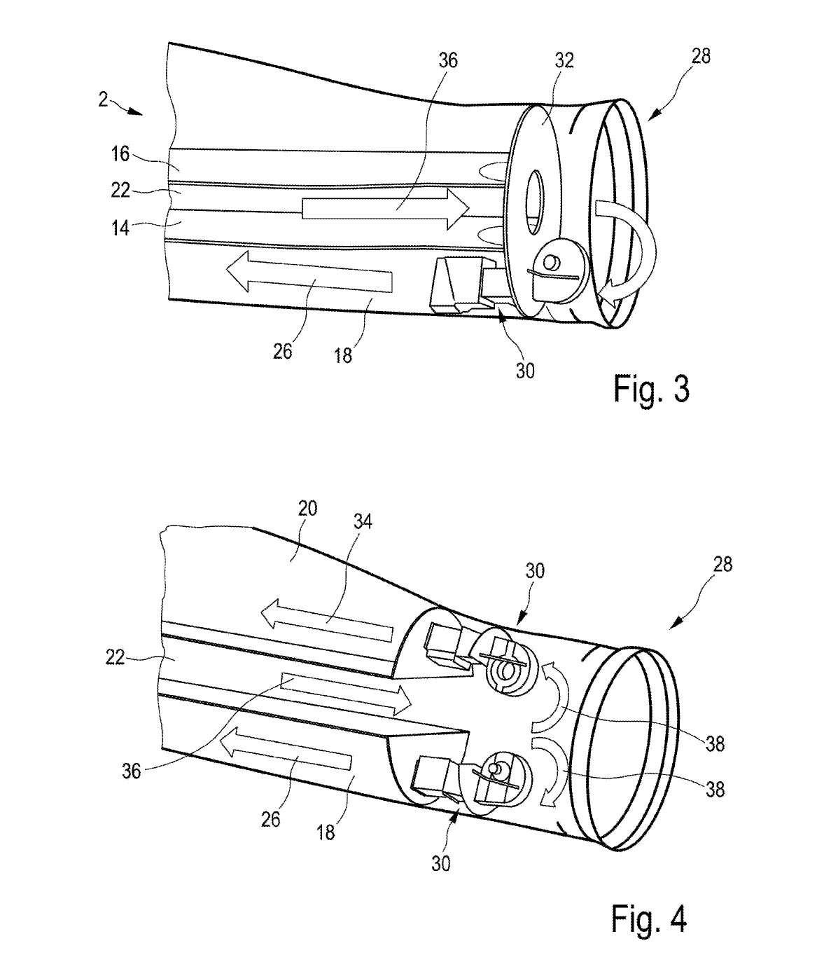

FIG. 3 illustrates the possibility of a first warm air current 26 in a first cavity 18 of the partially shown rotor blade. The perspective view in FIG. 3 thereby shows only the rotor blade body of the rotor blade 2, and therefore does not show the rear edge segment.

FIG. 3 clarifies that the first warm air current 26 in the middle cavity 22 can flow back as a return flow 36 between the two stiffening partitions 14 and 16 to the rotor blade root 28. There, the air from a heating means 30 can be again sucked in, heated and blown into the first cavity 18.

The same reference signs in FIGS. 2 to 9 have been selected for similar, however as the circumstances may require, not identical elements, in order to explain the corresponding relationships.

The cavities 18, 20 and 22 may be closed in the region of the rotor blade root 28 by a trailing edge cover 32, wherein the trailing edge cover 32 may have specific openings to channel the corresponding air currents, in particular specifically the forward current in the first and second cavity 18, 20 and return current in the middle cavity 22.

FIG. 4 shows the use of two heating means 30, by which the air is heated and blown into the first cavity 18, and conducted to the first warm air current 26 there. An additional heating means 30 heats air and blows it into the second cavity 20 and it results in a second warm air current 34. The first and the second cavity and the middle cavity may also be referred to as the first or second hollow chambers, respectively, or as the middle hollow chamber respectively. The second warm air current 34 thereby flows into the second cavity or the second hollow chamber respectively and the air of the first warm air current 26 and of the second warm air current 34 together are recycled as a return current 36 through the middle cavity 22 or the middle hollow chamber respectively to the root region 28. There, the return current or the return flow respectively is divided into two partial currents 38, specifically by the suction of the two heating means 30. These currents are then fed back accordingly to the first warm air current 26 or to the second warm air current 34, wherein a circulation is achieved.

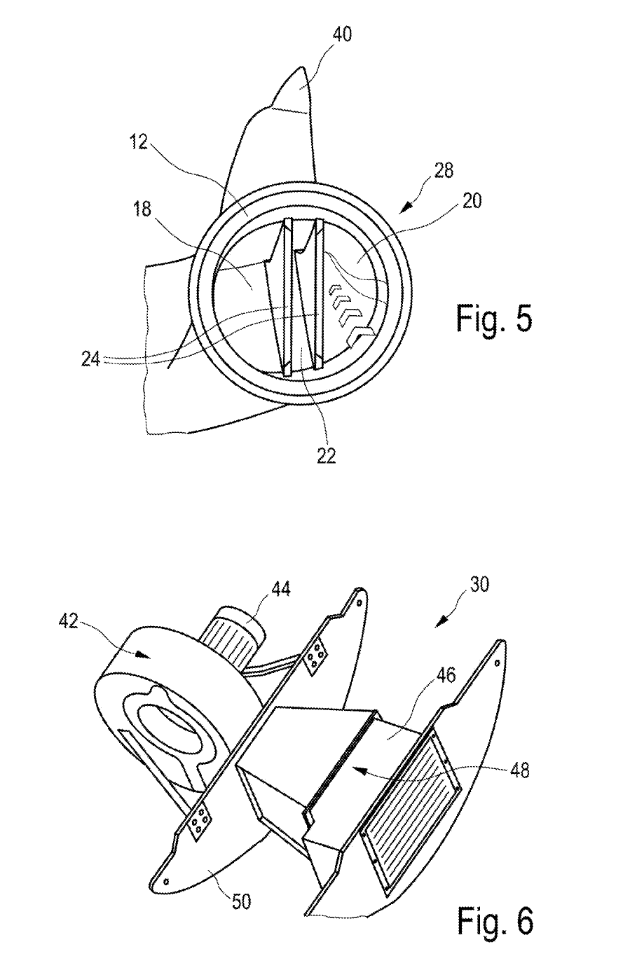

The view of the blade root region 28 pursuant to FIG. 5 shows the first, second and middle cavity 18, 20 and 22. The rotor blade tip 40 can be seen in the background. The middle cavity 22 is thereby essentially formed by the two stiffening partitions 24, supported by the outer shell 12.

FIG. 6 shows an enlarged illustration of a heating means 30, which essentially has a blower 42 including drive motor 44 and a heat register 46. The blower draws cool air and conducts it in and through the heat register 46. The air is thus warmed in the heat register 46 and blown into the first or second cavity respectively.

In addition, the heating means 30 has a closure section 48, which closes off the respective cavity, thus either the first cavity 18 or the second cavity 20, on the side of the rotor blade root, so that warm air that is blown in cannot escape there. An additional mounting projection 50 is provided, with which the heating means 30 may be internally mounted on an outer shell of the rotor blade and attached there. The heat registers preferably have heating outputs in the range of 10 kW to 75 kW as a nominal power. The capacity of the blower may lie in the range of 2100 m³/h to 5000 m³/h.

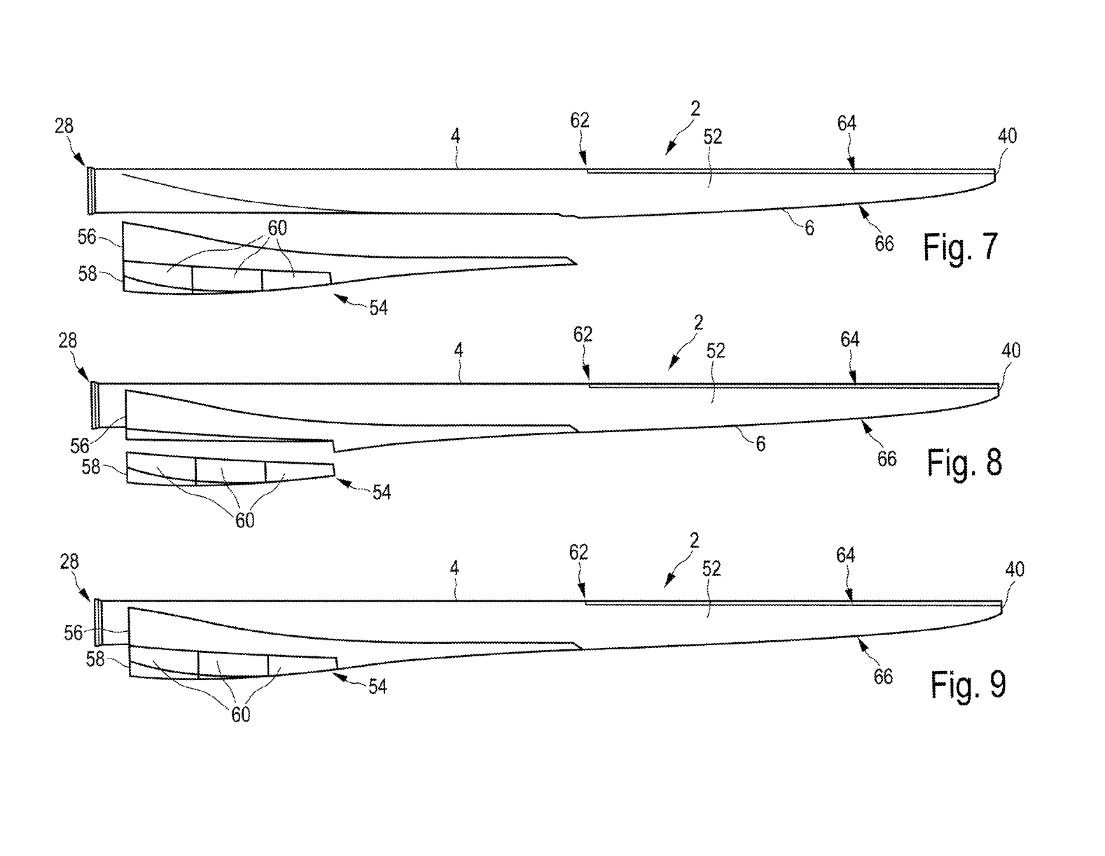

FIGS. 7 to 9 each show a rotor blade 2 having a rotor blade nose 4 and a rotor blade rear edge 6. The rotor blade 2 extends from the rotor blade root region 28 to the rotor blade tip 40. The rotor blade 2 thereby essentially comprises a rotor blade body 52 and a rear edge segment 54. The rear edge segment 54 is thereby divided into a base section 56 and an edge section 58. The base section 56 must be attached to the rotor blade body 52. The edge section 58, which is attached to the base section 56, is likewise subdivided, specifically into segment blocks 60. The three segment blocks 60 differ in terms of their concrete form, however for the sake of clarity, are provided with the same reference signs. The edge section 58, in particular the segment block 60 facing the rotor blade root region 28, has a profile that flattens out towards the rear. This takes into account the special flow conditions of the rotor blade in the region of the rotor blade root 28.

In FIG. 7, it can be seen that the rotor blade body 52 has a nearly unchanging width from its blade root 28 to the middle region 62, which is drawn approximately halfway between the rotor blade root 28 and rotor blade tip 40. Here, the rotor blade body is preferably manufactured as a winding body or wound body respectively. The rotor blade body at least has a wound main body as its basic structure. Here, this winding body is essentially cylindrical, specifically in the mathematical sense. Such a winding body is manufactured out of a fiber-reinforced material, in particular out of a glass fiber-reinforced or carbon fiber-reinforced plastic, and in particular wound in a plurality of layers having different fiber directions or fiber orientations respectively. The body may be wound having a tubular shape, thus a circular body in cross-section, or having an oval shape or polygonal shape having rounded corners. However the cross-section of this winding body, and thereby essentially the cross-section of the rotor blade body 52 of the rotor blade root 28, should remain essentially uniform in terms of shape and size up to approximately the middle region 62.

It has been recognized that with such a body, in particular a body wound in this manner, it is possible to achieve a thin, stable and thereby a comparatively light-weight design. Any shape that deviates in terms of the aerodynamic aspects can be supplemented. In so doing, smaller shapes may be formed during the manufacturing process of the main body 52, in particular by the manufacture of the rotor blade body in a corresponding production mold for the fiber-reinforced material. It is suggested that the rear edge segment 54 be provided for the rear edge region. This rear edge segment thus extends from the rotor blade root region 28 to the middle region 62 of the rotor blade 2. A substantial weight savings can be achieved as compared to conventional designs by means of this overall design. The proposed solution thereby includes a very long rear edge segment 54, which is essentially attached, e.g., adhered to the rotor blade body as a casing element or elements respectively.

In addition, FIGS. 7 to 9 illustrate various manufacturing steps or assembly steps for manufacturing and installing the rotor blade 2. Accordingly, the rotor blade body 52 pursuant to FIG. 7 is initially manufactured as a separate component. The rear edge segment 54 is likewise manufactured separately from the rotor blade body 52.

A delivery state of the rotor blade 2 is then shown pursuant to FIG. 8, specifically the manner in which the rotor blade 2 is prepared for transport to the installation site. The base edge section 56 is thereby already attached to the rotor blade body 52. The rear edge segment 56 is thereby designed in such a way that the transport size of the rotor blade 2 thus partially assembled is not substantially increased when in the mounted or attached state. The edge section 58 with the three segment blocks thereof 60 is not yet mounted or attached, as is clear in FIG. 8.

The edge section 58 is attached to the base section 56 and thereby to the rotor blade body 52 only after the transport of the rotor blade 2, specifically to the installation site of the respective wind turbine. The rotor blade 2 now has an overall size that is scarcely suitable for transport on the road. FIG. 9 shows these in an assembled state.

In addition, the Figures show the arrangement of an erosion protection cover 64 in the region of the rotor blade nose 4 to the rotor blade tip 40, which erosion protection cover is disposed in particular in the outer region of the rotor blade 2, thus in the area of the middle region 62 to the rotor blade tip 40 on the rotor blade nose 4. It is also suggested that this element be attached later, so the rotor blade body 52 can be manufactured independently therefrom.

A rotor blade trailing edge, as is proposed for each rotor blade 2 of one of the above described embodiments, is preferably advantageously provided in the outer region of the rotor blade, thus in the region from the middle region 62 to the rotor blade tip 40 in the region of the rear edge 6. Such a rotor blade trailing edge 66 may be provided as a three-dimensional, glass fiber-reinforced element and/or as an element made out of the same material as the rotor blade body 52. The formation as a three-dimensional trailing edge 66 thus suggests that this trailing edge 66 be designed and constructed in three dimensions. Thus what matters are the depth, width and height of the trailing edge 66. In particular it is suggested that a jagged rear edge be used here.

1. A rotor blade of a wind turbine, comprising:
a rotor blade nose,
a rotor blade rear edge,
a rotor blade root region for attaching the rotor blade hub of the wind turbine,
a rotor blade tip, wherein the rotor blade extends from the rotor blade root region along a longitudinal direction to the rotor blade tip, and
an internal portion that includes:
a first cavity proximate the blade nose,
a second cavity proximate the rotor blade rear edge,
a first heating means configured to heat the first cavity, and
second heating means configured to heat the second cavity.

2. The rotor blade according to claim 1, wherein the first and second heating means are disposed in the region of the rotor blade root are configured to heat air to blow said heated air into the first and second cavity, respectively.

3. The rotor blade according to claim 1, further comprising a middle cavity disposed between the first and second cavities, wherein the middle cavity is in fluid communication with the first and second cavities proximate the rotor blade tip such that the heated air that is blown into the first and second cavities from the rotor blade root region to the rotor blade is returned via the middle cavity to the rotor blade root region.

4. The rotor blade according to claim 3, wherein the air that is returned to the rotor blade root region is reheated and blown into the first or second cavities, respectively, recirculating to the rotor blade tip.

5. The rotor blade according to claim 1, wherein the first and second heating means are configured to be operated independently from one another.

6. The rotor blade according to claim 1, wherein the internal portion is divided into the first and second cavities by respective stiffening partitions, and a middle cavity is disposed between the respective stiffening partitions.

7. A rotor blade of a wind turbine, comprising:
a rotor blade nose,
a rotor blade rear edge,
a rotor blade root region configured to attach the rotor blade to a hub of the wind turbine,
a rotor blade tip, wherein the rotor blade has a length that extends from the rotor blade root region along a longitudinal direction to the rotor blade tip, and
a rear edge segment disposed in the region of the rotor blade rear edge up to the root region, wherein the rear edge segment includes a plurality of separable parts having at least two segment sections.

8. The rotor blade according to claim 7, wherein the rear edge segment extends from the rotor blade root region in the longitudinal direction for more than 40% of the length of the rotor blade.

9. The rotor blade according to claim 7, wherein:
the rotor blade has a rotor blade body,
the rear edge segment is a separate component configured to be attached to the rotor blade body, and
the rear edge segment has a base section for attachment to the rotor blade body and an edge section for attachment to the base section.

10. The rotor blade according to claim 9, wherein at least one of the base section and the edge section include a plurality of parts.

11. A rear edge segment of a rotor blade, comprising:
a base section configured to be coupled direction to the rotor blade; and
an edge section configured to be attached to the base section, the edge section, wherein the edge section includes a plurality of separable parts.

12. The rear edge segment according to claim 11, wherein said rear edge segment is coupled to a rotor blade comprising:
a rotor blade nose;
a rotor blade rear edge;
a rotor blade root region for attaching the rotor blade to a hub of the wind turbine;
a rotor blade tip, wherein the rotor blade extends from the rotor blade root region along a longitudinal direction to the rotor blade tip; and
an internal portion that includes:
a first cavity proximate the blade nose,
a second cavity proximate the rotor blade rear edge,
first heating means configured to heat the first cavity, and
second heating means configured to heat the second cavity.

13. A wind turbine comprising: at least one rotor blade according to claim 1.

14. A method for manufacturing a rotor blade, comprising the steps:
forming a rotor blade body,
forming a base section of a rear edge segment,
forming an edge section of the rear edge segment,
attaching the base section to the rotor blade body, and
attaching the edge section to the base section.

15. A method, comprising the steps:
forming a rotor blade body of a rotor,
forming a base section of a rear edge segment of the rotor blade,
forming an edge section of the rear edge segment,
attaching the base section to the rotor blade body,
transporting the edge section and the rotor blade body with the attached base section to an installation site of a wind turbine, and
at the installation site, attaching the edge section to the base section that is attached to the rotor blade body.

16. The method according to claim 15, further comprising attaching the rotor blade to a rotor of the wind turbine.

17. The rotor blade according to claim 7, wherein the rear edge segment extends from the rotor blade root region in the longitudinal direction for more than 45% of the length of rotor blade.
